(19) United States
(12) Patent Application Publication
(10) Pub. No.: US 2023/0311351 A1
(43) Pub. Date: Oct. 5, 2023

(54) Dermaplane Cutting Device

(71) Applicant: Leaf Shave Company, Pittsburgh, PA (US)

(72) Inventors: Adam J. Hahn, Pittsburgh, PA (US); Benjamin McCandless, Captain Cook, HI (US)

(21) Appl. No.: 18/127,059

(22) Filed: Mar. 28, 2023

Related U.S. Application Data
(60) Provisional application No. 63/325,279, filed on Mar. 30, 2022.

(51) Int. Cl. B26B 21/40; B26B 21/10; B26B 21/52; B26B 21/56

(52) U.S. Cl. CPC B26B 21/4043; B26B 21/10; B26B 21/4018; B26B 21/521; B26B 21/565; B26B 21/522; A45D 26/0004

(57) ABSTRACT

A dermaplane razor device, including a first end operatively connected to a second end, the first end including a holder configured to hold a razor blade; the second end configured for handling; a cover lock rotatably connected to the second end and configured to hold the razor blade within the holder, the cover lock including a handle and locking mechanism; where the cover lock rotates to contact the first end and removably fix the razor blade so that a cutting edge of the razor blade is extends past the holder.

This application claims priority to U.S. Provisional Patent Application No. 63/325,279 filed Mar. 30, 2022, the disclosure of which is hereby incorporated by reference in its entirety.

### BACKGROUND OF THE INVENTION

### Field of the Invention

This disclosure relates generally to razors and, more particularly, to a dermaplaning razor with replaceable blades and replaceable guards for exfoliating the skin and shaving off fine hairs.

### Description of Related Art

Razors have become ubiquitous and are used by both men and women for their personal shaving needs. Straight-blade razors, which are made of high carbon or stainless steel, exemplify the early modern popular style of shaving implements. These razors can be used for many shaving sessions over a longer period of time, but must be maintained by regular sharpening or stropping. The process of sharpening, or honing, the blade uses an abrasive material that removes material from the blade's edge. Stropping, which must be done with each use of a straight-blade razor, straightens and re-aligns the blade, which tends to bend and pit under use preventing a close shave if not straightened.

While most people are familiar with using razors for grooming hair on the face and elsewhere, razor blades can also be used for exfoliation of the skin. Using a razor blade to remove fine facial hair, known as “vellus hair” or “peach fuzz” and dead skin cells from the face is frequently referred to as dermaplaning. This process is marketed as improving skin health and users indicate that it may help with the absorption of beauty products into the skin and in some cases, reducing hyperpigmentation.

A dermaplane is a tool used for this exfoliation and hair removal. It consists of a sharp edge, which is scraped along the skin at approximately a 45 degree angle. When done by a professional, one might find a scalpel with an appropriately shaped blade used as a dermaplane, but a variety of consumer products are available that provide the benefits of dermaplaning while reducing the risk of serious injury that may come from careless handling of a sharp edge.

Periodically, dermaplane users wish to use the device to perform detailed hair removal. Examples of this include shaping eyebrows, trimming mustaches, and removing hair from around the ears and other grooming areas. Many of these grooming tasks involve highly visible areas, such as the user's face, and great care must be taken to ensure a good result. When performing these precision grooming tasks, it is common to work only with the end of the exposed dermaplane blade. Limiting exposure of the blade ensures that slight variations in position and pressure will not result in unintended overcutting of hair. To limit this exposure, a user may make use of a shield that covers a portion of the blade, preventing it from cutting any hair while the user focuses on the area of interest.

Most commercially available dermaplanes provide a handle that lies in the same plane as the blade edge, usually slightly angled back so that the blade can be comfortably worked around facial features. Similarly to consumer razors, most models have a reusable handle and a disposable cartridge, where the cartridge contains the blade and a guard of some sort to prevent the user from injuring themselves in more than a superficial manner. As the blades become dull with use, the cartridge (or the entire dermaplane) is discarded, then replaced.

Current dermaplane blades are either incorporated into wasteful and expensive disposable cartridges, or designed so that the entire dermaplane is disposable. Users are encouraged to dispose of a blade after every use, rather than when performance is no longer satisfactory. The heavy use of integral injection molded plastic in current dermaplane cartridges and disposable dermaplanes frequently results in structures that users cannot be separate from the metal portions for recycling. Since the blade cartridges or disposable dermaplanes are mixed plastic and metal, they cannot be recycled and are typically sent to a landfill. In addition, the shields used for detailed hair removal are frequently made of plastic, and disposed of with each cartridge, adding to the waste stream generated by these products.

### SUMMARY OF THE INVENTION

In accordance with an aspect of the disclosure, a dermaplane razor device, comprising: a first end operatively connected to a second end, the first end comprising a holder configured to hold a razor blade; the second end configured for handling; a cover lock rotatably connected to the second end and configured to hold the razor blade within the holder, the cover lock comprising a handle and locking mechanism; wherein the cover lock rotates to contact the first end and removably fix the razor blade so that a cutting edge of the razor blade extends past the holder.

In accordance with another aspect of the disclosure, the dermaplane razor device further comprises a guard configured to hold the razor blade within the holder so that a cutting edge of the razor blade is exposed, the guard having a scalloped edge so that the cutting edge of the razor blade is at least partially exposed.

In accordance with another aspect of the disclosure, the dermaplane razor device includes the handle of the cover lock has a cut out section which meets a cut out section of the second end configured for aiding in the rotation of the handle and separation of the cover lock from the holder.

In accordance with another aspect of the disclosure, the dermaplane razor device includes the holder configured to hold a razor blade further comprises: a first hold end and a second hold end configured to hold a blade having ends; a top cut away section that when the cover lock is secured against the first end, is still exposed to allow for additional cutting means to extend through; and an end of the holder configured to releaseably lock the cover lock to the holder.

In accordance with another aspect of the disclosure, the dermaplane razor device includes the holder configured to hold the guard further comprises a dug out section configured to hold the guard.

In accordance with another aspect of the disclosure, the dermaplane razor device includes the dug out section comprises a rounded end and an open end, the open end being further from the second end than the rounded end.

In accordance with another aspect of the disclosure, the dermaplane razor device further comprises a precision guard configured to couple to the first end and at least partially covers the cutting edge of the razor blade.

In accordance with another aspect of the disclosure, the dermaplane razor device includes the precision guard is slidably coupled to the first end and at least partially covers the cutting edge of the razor blade.

In accordance with another aspect of the disclosure, the dermaplane razor device includes the precision guard comprises a hook end ergonomically configured to aid in controlling the device.

In accordance with another aspect of the disclosure, a dermaplane razor device comprises a singular bar comprising a first end and a second end separated at a midpoint, the first end comprising a holder configured to hold a razor blade, the holder comprising an opening configured to expose a cutting edge of the razor blade; the second end configured for handling; a cover lock rotatably connected to the midpoint, the cover lock configured to hold the razor blade within the holder, the cover lock comprising a handle and locking mechanism; wherein the cover lock rotates to contact the first end and removably fix the razor blade so that the cutting edge of the razor blade is extended past the holder such that when the cover lock rotates the handle stops before contact with the holder.

In accordance with another aspect of the disclosure, the dermaplane razor device further comprises a guard configured to hold the razor blade within the holder so that a cutting edge of the razor blade is exposed, the guard having a scalloped edge so that the cutting edge of the razor blade is at least partially exposed.

In accordance with another aspect of the disclosure, the dermaplane razor device includes the handle of the cover lock has a cut out section which meets a cut out section of the second end configured for aiding in the rotation of the handle and separation of the cover lock from the holder.

In accordance with another aspect of the disclosure, the dermaplane razor device includes the holder configured to hold a razor blade further comprises: a first hold end and a second hold end configured to hold a blade having ends; a top cut away section that when the cover lock is secured against the first end, is still exposed to allow for additional cutting means to extend through; and an end of the holder configured to releaseably lock the cover lock to the holder.

In accordance with another aspect of the disclosure, the dermaplane razor device includes the holder configured to hold the guard further comprises a dug out section configured to hold the guard.

In accordance with another aspect of the disclosure, the dermaplane razor device further comprises a precision guard configured to couple to the first end and at least partially covers the cutting edge of the razor blade.

In accordance with another aspect of the disclosure, the dermaplane razor device includes the precision guard is slidably coupled to the first end and at least partially covers the cutting edge of the razor blade.

In accordance with another aspect of the disclosure, a dermaplane razor device comprises: a singular bar comprising a first end and a second end separated at a midpoint, the first end comprising a holder configured to hold a razor blade, the holder comprising an opening configured to expose a cutting edge of the razor blade and a dug out section configured to hold a guard; the guard configured to hold the razor blade within the holder so that a cutting edge of the razor blade is exposed, the guard having a scalloped edge so that the cutting edge of the razor blade is at least partially exposed; the second end configured for handling; a cover lock rotatably connected to the midpoint, the cover lock configured to hold the razor blade within the holder, the cover lock comprising a handle and locking mechanism; wherein the cover lock rotates to contact the first end and removably fix the razor blade so that the cutting edge of the razor blade is extended past the holder such that when the cover lock rotates the handle stops before contact with the holder.

In accordance with another aspect of the disclosure, the dermaplane razor device includes the first end is configured to hold a non cutting edge of the razor within a first holder end and a second holder end.

In accordance with another aspect of the disclosure, a method for installing a razor into the device comprises: rotating the cover lock to an open position; installing the guard into the dug out section; installing the razor into the guard such that the cutting edge is exposed from the holder and the noncutting edge of the razor is proximate to the first and second holder end; and rotating the cover lock to a closed position.

In accordance with another aspect of the disclosure, the method further comprises releasably clipping a precision guard to the first end such that the cutting edge of the razor is at least partially covered.

### BRIEF DESCRIPTION OF THE DRAWINGS

FIG. 1 is a side view of a dermaplane cutting device;

FIG. 2 is a front view of a dermaplane cutting device;

FIG. 3 is a perspective view of a dermaplane cutting device;

FIG. 4 is a perspective view of a first end of a dermaplane with the holder and the cover lock in an unlocked position;

FIG. 5 is a side view of a dermaplane cutting device with the cover lock in an unlocked position;

FIG. 6 is a perspective view of a dermaplane cutting device with the cover lock in an unlocked position;

FIG. 7 is a perspective view and cross section of a holder of a first end of a dermaplane;

FIG. 8 is a perspective view of a holder of a first end of a dermaplane with a razor and a guard;

FIG. 9 is another perspective view and cross section of a holder of a first end of a dermaplane with a razor and a guard;

FIG. 10 is another perspective view and cross section of a holder of a first end of a dermaplane with a guard;

FIG. 11 is a side view of a guard;

FIG. 12 is a perspective view of a guard;

FIG. 13 is a perspective view of the first end of the dermaplane;

FIG. 14 is a side view of a precision guard;

FIG. 15 is another side view of a precision guard;

FIG. 16 is a back view of a precision guard;

FIG. 17 is a perspective view of a precision guard installed on dermaplane cutting device; and

FIG. 18 is a perspective view of a precision guard installed in another position on dermaplane cutting device.

### DESCRIPTION OF THE INVENTION

For purposes of the description hereinafter, spatial orientation terms, as used, shall relate to the referenced aspect as it is oriented in the accompanying drawings, figures, or otherwise described in the following detailed description. However, it is to be understood that the aspects described hereinafter may assume many alternative variations and configurations. It is also to be understood that the specific components, devices, features, and operational sequences illustrated in the accompanying drawings, figures, or otherwise described herein are simply exemplary and should not be considered as limiting.

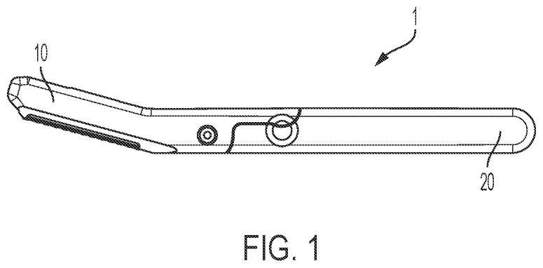

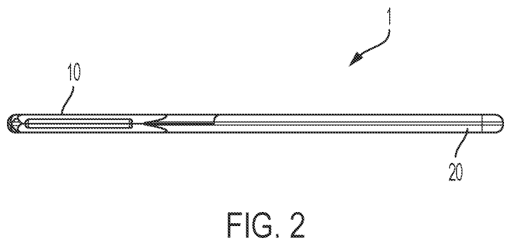

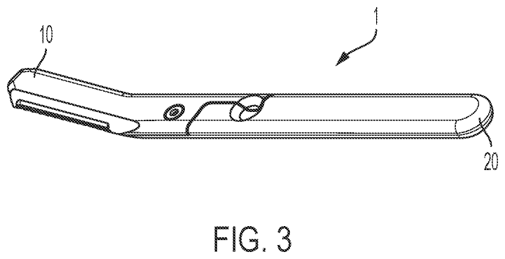

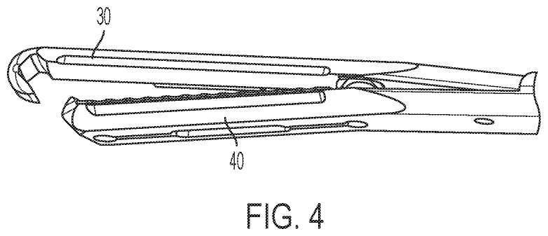

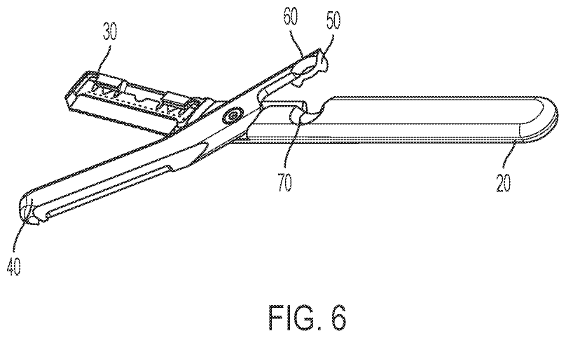

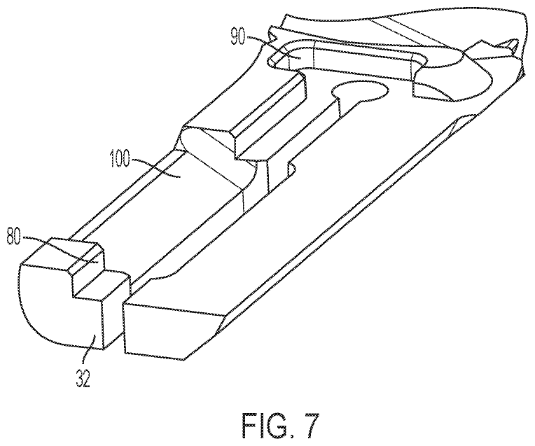

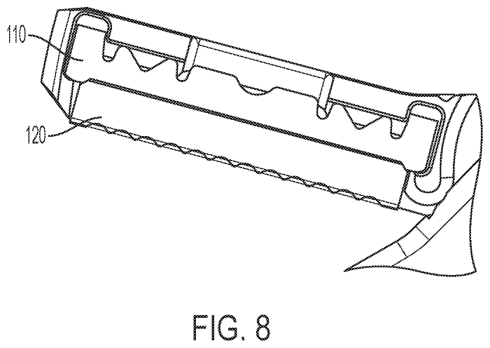

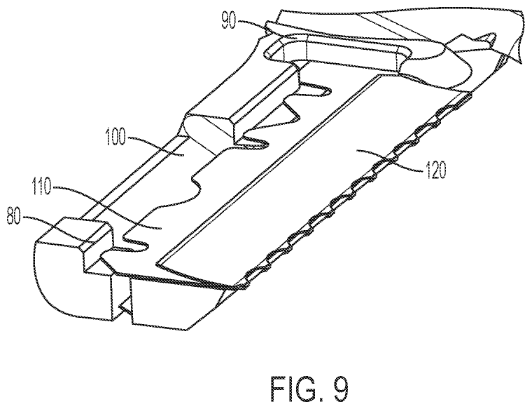

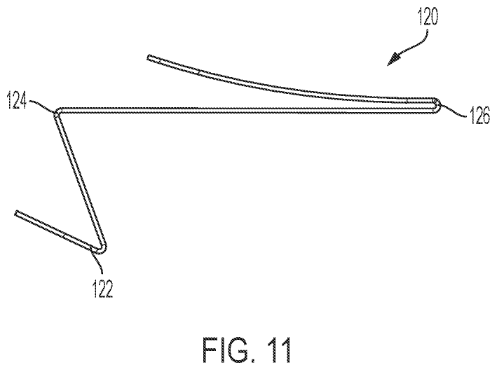

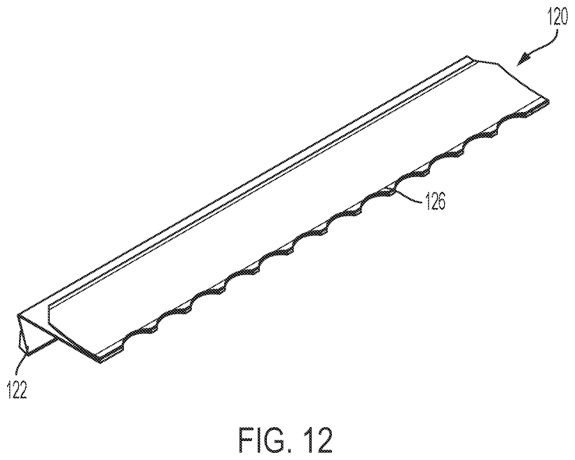

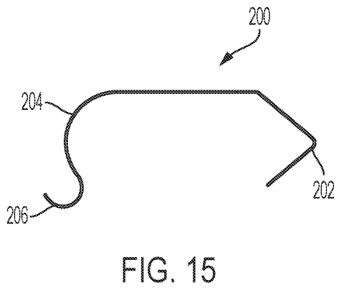

The present disclosure is directed to, in general, a dermaplane razor and, in particular, a dermaplane razor with replaceable blades. Certain preferred and non-limiting aspects of the components of the dermaplane razor are illustrated in FIGS. 1-15.

With reference to FIGS. 1-4, one aspect of a dermaplane razor device 1 (also referred to as “razor 1”) is described. The razor 1 may include a first end 10 and a second end 20. In one aspect, the first end 10 may include a holder 30 configured to hold a razor blade in addition to a razor guard. The second end 20 may be configured for handling by a user and may be ergonomically shaped to fit in a user's hand for an ease of operability. The first end 10 may have a cover lock 40 rotatably connected to the second end 20. The cover lock 40 may rotate about the connection point to the second end 20. The cover lock 40 may be connected to the second end 20 by any connection means. The cover lock 40 may be removed via the connection point for maintenance or operability purposes. The holder 30 of the first end 10 and the cover lock 40 may be configured to contact on another when the cover lock 40 is not in a rotated position. The cover lock 40 may have a locking means to lock the cover lock 40 to the holder 30, to releasably fix a razor with an exposed cutting edge for cutting a cutting surface. The locking means may be at the end of the holder 30. The holder 30 and cover lock 40 may be shaped so that when in the locked position, the distal portions of the holder 30 and the cover lock 40 are interlocking. While in the locked position, the razor blade 110 and guard 120 are fixed with a cutting edge exposed.

The first end 10 and the second end 20 may be connected so that the first end 10 and second end 20 form a 0 to 90 degree angle, but preferably a 5 to 45 degree angle. The angled connection advantageously allows the cutting edge of the razor to contact the cutting surface at irregular positions and locations.

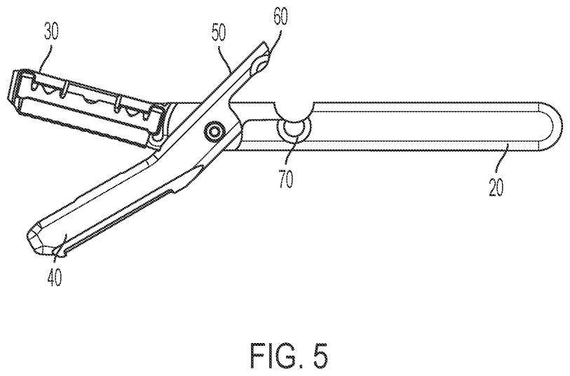

With reference to FIGS. 5-9, one aspect of the dermaplane razor device 1, may include a handle 50 on the cover lock 40. The handle 50 may be shaped to align with the second end 20 when in a locked position so that no part of the handle 50 is exposed outwardly. The handle 50 may extend any length up to the end of the second end 20. The cover lock 40 may rotate clockwise or counter clockwise with reference to the connection point between the first end 10 and the second end 20. The handle 50 advantageously aids the user in rotating the cover lock 40 between the locked and unlocked position. The handle 50 may have a cut out 60 which, when the cover lock 40 is in the locked position, aligns with a cut out 70 of the second end 20. The cut outs 60, 70 advantageously aid the user in separating the handle 50 from the second end 20 when rotating the cover lock 40. The cut outs 60, 70 may be of any geometric shape.

The holder 30 of the first end 10 may have a section configured for placement of a blade 110 and guard 120. The cover lock 40 may, when in a locked position, further secure the blade 110 and guard 120 with the holder 30. The holder 30 may include a first holder end 80, second holder end 90, and top cut away 100. The first holder end 80 and second holder end 90 are configured to receive and hold the blade 110 and guard 120. The cover lock 40 may also have a similar configuration to receive and hold the blade 110 and guard 120. A top cut away 100 may be positioned between the first holder end 80 and second holder end 90. The top cut away 100 may be configured to allow for a passage to the external surface of the first end 10.

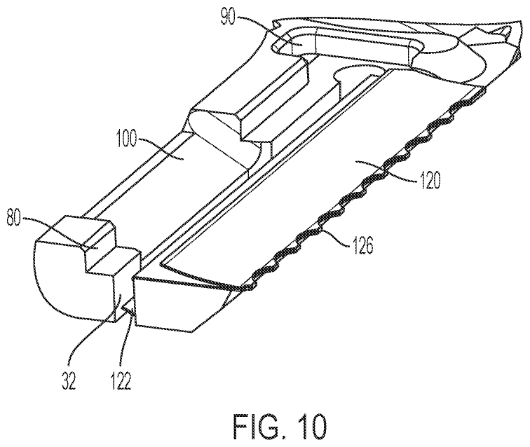

With reference to FIGS. 10-12, a guard 120 is configured to be held by the holder 30 of the first end 10 and cover lock 40. The guard 120 may act as a spring to hold the blade 110 and a cutting edge of the blade 110 in a desired location. The guard 120 may act as a spring to apply tension to the cover lock 40. The guard 120 is replaceable and also reusable. The guard 120 may advantageously act as a spring to increase the ease of installation of the blade 110 while providing friction to hold the cover lock 40 in the locked position. The guard 120 may have multiple bends which may act to put tension on the blade 110 to further secure the blade 110 to the holder 30. By putting tension on the blade 110, the guard 120 may additionally pull the blade 110 into a position which exposes the cutting edge.

The guard 120 may partially cover the cutting edge of the blade 110. An extension 122 of the guard 120 may extend into the trench 32 to secure the guard 120 and thereby secure the blade 110. The extension 122 is long enough to at least partially extend into the trench 32. Bend 124 may be bent at a greater angle than the angle of where the trench 32 and the first end holder 80 meet. This greater angle of bend 124 further secures the guard 120, and in turn the blade 110, by applying tension against the trench 32 and first end holder 80.

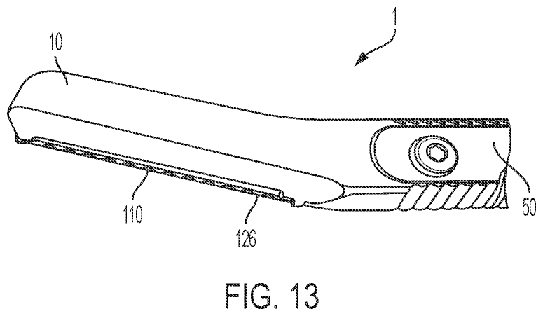

The guard 120, may also have a scalloped edge 126. The cutting edge of the blade 110 may contact the scalloped edge 126. The cutting edge may be partially exposed due to the scalloped edge 126, which advantageously increases the safety of operation by preventing the cutting edge of the blade 110 from incorrectly cutting the cutting surface and injuring the user. The scalloped edge 126 may include cut outs of any shape exposing the cutting edge of the blade 110. With reference to FIG. 13, the scalloped edge 126 and the cutting edge of the blade 110 are exposed out of the first end 10.

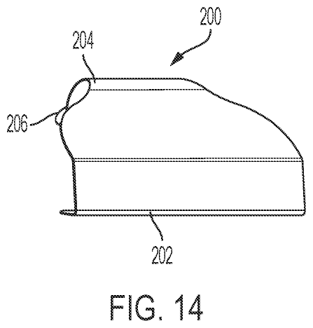

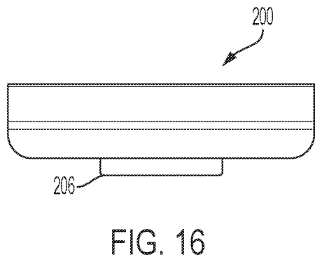

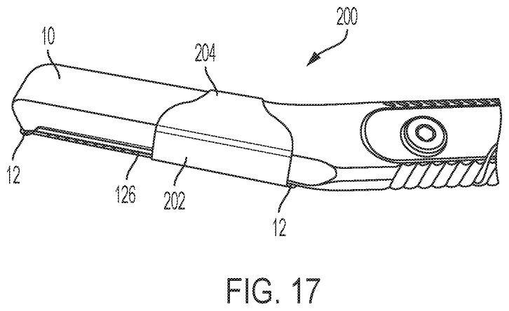

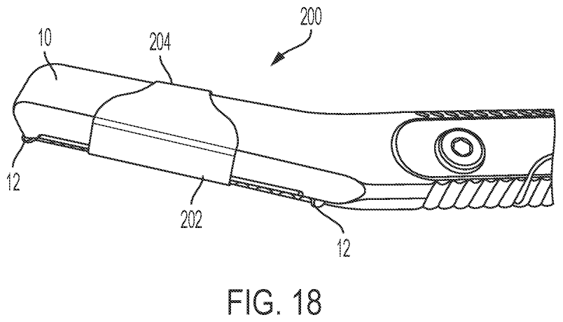

With reference to FIGS. 14-18, a precision guard 200 is configured to attach to the first end 10 of the dermaplane device 1. The precision guard 200 may attach by clipping on or slideably connecting. The precision guard 200 is shaped to fit over the first end 10 and oriented such that the precision guard 200 aligns with the first end 10 and the exposed cutting edge of the blade 110. A back rounded end 204 of the precision guard 200 may contact a surface of the first end 10 opposite the exposed cutting edge of the blade 110. A V-section 202 of the precision guard 200 may be shaped to cover the exposed cutting edge of the blade 110 when the precision guard 200 is attached to the first end 10. While the precision guard 200 is attached, the cutting edge of the blade 110 and scalloped edge 126 of the guard 120 are partially covered and partially exposed. This advantageously increases the accuracy and detailing abilities of the dermaplane device 1 that a user desires. The precision guard 200 may be made of any material similar to a metal or plastic. The precision guard 200, while configured to attach to the first end 10 may also attach to the second end 20 for storing while the use of the precision guard 200 is not desired. The precision guard may also include a handle 206. The handle 206 is configured to increase the gripping capability of the precision guard 200 to advantageously increase the accuracy and detailing abilities of the dermaplane device 1 while in use. While the precision guard 200 is attached to the second end 20, the handle 206 may aid in increasing the grip as well. The precision guard 200 is also configured to slide to expose different sections of the cutting edge of the blade 110 and scalloped edge 126 of the guard 120 as desired. The first end 10 includes tabs 12 which protrude from the bottom of the first end 10 in the direction of the cutting edge of the blade 110. The tabs 12 are configured to prevent the precision guard 200 from sliding off of the first end 10.

While aspects of a razor are shown in the accompanying figures and described herein above in detail, other aspects will be apparent to, and readily made by, those skilled in the art without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope. It is also contemplated that any feature from one aspect of the disclosure may be incorporated with the features of any other aspect of the disclosure.

The invention claimed is:

1. A dermaplane razor device, comprising:
a first end operatively connected to a second end, the first end comprising a holder configured to hold a razor blade;
the second end configured for handling;
a cover lock rotatably connected to the second end and configured to hold the razor blade within the holder, the cover lock comprising a handle and locking mechanism; wherein the cover lock rotates to contact the first end and removably fix the razor blade so that a cutting edge of the razor blade extends past the holder.

2. The dermaplane razor device of claim 1, further comprising a guard configured to hold the razor blade within the holder so that a cutting edge of the razor blade is exposed, the guard having a scalloped edge so that the cutting edge of the razor blade is at least partially exposed.

3. The dermaplane razor device of claim 1, wherein the handle of the cover lock has a cut out section which meets a cut out section of the second end configured for aiding in the rotation of the handle and separation of the cover lock from the holder.

4. The dermaplane razor device of claim 1, wherein the holder configured to hold a razor blade further comprises:
a first hold end and a second hold end configured to hold a blade having ends;
a top cut away section that when the cover lock is secured against the first end, is still exposed to allow for additional cutting means to extend through; and
an end of the holder configured to releaseably lock to the cover lock to the holder.

5. The dermaplane razor device of claim 4, wherein the holder configured to hold the guard further comprises a dug out section configured to hold the guard.

6. The dermaplane razor device of claim 5, wherein the dug out section comprises a rounded end and an open end, the open end being further from the second end than the rounded end.

7. The dermaplane razor device of claim 1, further comprising a precision guard configured to couple to the first end and at least partially covers the cutting edge of the razor blade.

8. The dermaplane razor device of claim 7, wherein the precision guard is slidably coupled to the first end and at least partially covers the cutting edge of the razor blade.

9. The dermaplane razor device of claim 7, wherein the precision guard comprises a hook end ergonomically configured to aid in controlling the device.

10. A dermaplane razor device, comprising:
a singular bar comprising a first end and a second end separated at a midpoint, the first end comprising a holder configured to hold a razor blade, the holder comprising an opening configured to expose a cutting edge of the razor blade;
the second end configured for handling;
a cover lock rotatably connected to the midpoint, the cover lock configured to hold the razor blade within the holder, the cover lock comprising a handle and locking mechanism; wherein the cover lock rotates to contact the first end and removably fix the razor blade so that the cutting edge of the razor blade is extended past the holder such that when the cover lock rotates the handle stops before contact with the holder.

11. The dermaplane razor device of claim 10, further comprising a guard configured to hold the razor blade within the holder so that a cutting edge of the razor blade is exposed, the guard having a scalloped edge so that the cutting edge of the razor blade is at least partially exposed.

12. The dermaplane razor device of claim 10, wherein the handle of the cover lock has a cut out section which meets a cut out section of the second end configured for aiding in the rotation of the handle and separation of the cover lock from the holder.

13. The dermaplane razor device of claim 10, wherein the holder configured to hold a razor blade further comprises:
a first hold end and a second hold end configured to hold a blade having ends;
a top cut away section that when the cover lock is secured against the first end, is still exposed to allow for additional cutting means to extend through; and
an end of the holder configured to releaseably lock to the cover lock to the holder.

14. The dermaplane razor device of claim 13, wherein the holder configured to hold the guard further comprises a dug out section configured to hold the guard.

15. The dermaplane razor device of claim 10, further comprising a precision guard configured to couple to the first end and at least partially cover the cutting edge of the razor blade.

16. The dermaplane razor device of claim 15, wherein the precision guard is slidably coupled to the first end and at least partially cover the cutting edge of the razor blade.

17. A dermaplane razor device, comprising:
a singular bar comprising a first end and a second end separated at a midpoint, the first end comprising a holder configured to hold a razor blade, the holder comprising an opening configured to expose a cutting edge of the razor blade and a dug out section configured to hold a guard;
the guard configured to hold the razor blade within the holder so that a cutting edge of the razor blade is exposed, the guard having a scalloped edge so that the cutting edge of the razor blade is at least partially exposed;
the second end configured for handling;
a cover lock rotatably connected to the midpoint, the cover lock configured to hold the razor blade within the holder, the cover lock comprising a handle and locking mechanism; wherein the cover lock rotates to contact the first end and removably fix the razor blade so that the cutting edge of the razor blade is extended past the holder such that when the cover lock rotates the handle stops before contact with the holder.

18. The dermaplane razor device of claim 17, wherein the first end is configured to hold a non cutting edge of the razor within a first holder end and a second holder end.

19. A method for installing a razor into the device of claim 17, comprising:
rotating the cover lock to an open position;
installing the guard into the dug out section;
installing the razor into the guard such that the cutting edge is exposed from the holder and the noncutting edge of the razor is proximate to the first and second holder end; and
rotating the cover lock to a closed position.

20. The method of claim 19, further comprising: releasably clipping a precision guard to the first end such that the cutting edge of the razor is at least partially covered.
